(19) United States
(12) Patent Application Publication
(10) Pub. No.: US 2012/0142801 A1
(43) Pub. Date: Jun. 7, 2012

(54) CORE FOAMS OF POLYURETHANE FOR PRODUCTION OF WINGS AND BLADES FOR WIND POWER SYSTEMS IN PARTICULAR

(75) Inventors: Frank PRISSOK, Lemforde (DE); Marco Balbo Block, Osnabruck (DE); Zhenyu Qian, Shanghai (CN); Daniel Freidank, Lemforde (DE); Dietrich Scherzer, Neustadt (DE); Ingrid Martin, Lemforde (DE)

(73) Assignee: BASF SE, Ludwigshafen (DE)

(21) Appl. No.: 13/307,543

(22) Filed: Nov. 30, 2011

Related U.S. Application Data
(60) Provisional application No. 61/418,414, filed on Dec. 1, 2010.

(51) Int. Cl. C08J 9/00; C08L 75/04

(52) U.S. Cl. 521/170

(57) ABSTRACT

A reinforced polyurethane foam obtained by (1) mixing polyisocyanates (a) with compounds having isocyanate-reactive groups (b), a blowing agent containing water (c), and optionally a catalyst (d) and further additives (e) to form a reaction mixture, and (2) curing the reaction mixture, where the reaction mixture to be cured contains hollow microspheres and/or is applied to a porous reinforcing agent (f) capable of forming two-dimensional or three-dimensional networks in the polyurethane foam. The compounds having isocyanate-reactive groups (b) include polyetherols (b1), polyesterols (b2), chain extenders (b3) and optionally crosslinkers (b4) and aromatic polyether diols (b5), and the sum of (b2), (b3) and (b5) is at least 50% by weight of component (b). A process for producing such reinforced polyurethane foams and their use as reinforcing foams for load-bearing, stiff areal elements, in the interior of wings or blades, and also as insulation material for liquefied natural gas tanks.

The present invention relates to a reinforced polyurethane foam having a density of above 50 to 300 g/L, a density-independent compressive strength of above 7.5*10⁻⁴ MPa (L/g)^{1.6}, a density-independent compressive modulus of elasticity of above 1.7*10⁻² MPa (L/g)^{1.7}, a density-independent tensile strength of above 6.4*10⁻⁴ MPa (L/g)^{1.6}, a density-independent tensile modulus of elasticity of above 2.4*10⁻² MPa (L/g)^{1.7}, a density-independent flexural strength of above 1.25*10⁻³ MPa (L/g)^{1.6}, and a density-independent flexural modulus of elasticity of above 1.75*10⁻² MPa (L/g)^{1.7}, obtainable by mixing (a) polyisocyanates with (b) compounds having isocyanate-reactive groups, (c) blowing agent comprising water, and optionally (d) catalyst and (e) further additives, to form a reaction mixture and curing the reaction mixture, wherein the reaction mixture to be cured comprises from 1% to 40% by weight of hollow microspheres and/or is applied to a porous reinforcing agent (f) capable of forming two-dimensional or three-dimensional networks in the polyurethane foam, the compounds having isocyanate-reactive groups (b) comprise polyetherols (b1), polyesterols (b2), chain extenders (b3) and optionally crosslinkers (b4) and aromatic polyether diols (b5), and said component (b) comprises a fraction of polyesterols (b2), chain extenders (b3) and aromatic polyether diol (b5) that is equal to at least 50% by weight, based on the total weight of said component (b). The present invention further relates to a process for producing such reinforced polyurethane foams and to their use as reinforcing foams for load-bearing, stiff areal elements, in the interior of wings or blades, and also as insulation material for liquefied natural gas tanks.

Reinforced rigid foams based on polyurethanes are known and are described in WO 2010/066635 or WO 2008/083996 for example. These foams are used for example as insulation material for liquefied natural gas (LNG) tanks and more particularly on LNG carriers. Such insulation materials have to meet high mechanical requirements, since they perform a load-bearing function in relation to the LNG tank as well as an insulating function. High compressive strengths, a high compressive modulus of elasticity and also a high shear strength are required here in particular. Although existing foams already offer very good properties, an improvement in these properties, more particularly the elasticity, is desirable. Vibrations as encountered during transportation in LNG carriers on rough seas for example can be more effectively absorbed as a result.

Rigid foams having very good mechanical properties have further applications. For instance, these foams are used in wings of sporting aircraft, such as gliders for example, or in rotor blades of wind power systems for example. The material currently most commonly used for reinforcement in blades and wings is balsa wood, foam based on crosslinked polyvinyl chloride and foam based on polyethylene terephthalate.

The disadvantage with these materials used for reinforcement in blades and wings is that balsa wood is a natural resource and hence is costly and not widely available; that manufacturing processes for foam based on crosslinked polyvinyl chloride are very inconvenient and have an adverse environmental impact due to the high halogen content; and that the mechanical properties of foam based on polyethylene terephthalate are in need of improvement.

Furthermore, wind power generation in particular appears to trend to ever larger turbine systems with longer blades. This feature typically involves applying a load-bearing glass fiber/reactive resin layer to the reinforcing foam. The reactive resins used are mainly epoxy resins or polyester resins. These resins evolve heat of reaction, or have to be heated.

The ever larger blades increase the mechanical demands on these load-bearing glass fiber/reactive resin systems used as an outside layer. To meet these mechanical demands, the usual thing done is to increase the thickness of the outside layer. As a result, the temperature involved in curing rises.

There are also efforts, motivated by the rising production figures in particular, to shorten the manufacturing process and hence the curing times of the blades and, more particularly, of the outside layers. This can be done by raising the curing temperature for example. However, reinforcing foams based on crosslinked polyvinyl chloride in particular suffer a permanent loss of mechanical stability on heating to elevated temperatures, such as temperatures above 75° C. for example.

It is further an essential requirement of wind power rotor blades in particular that they respond to high loads elastically in that they are able to flex to a certain degree. The same holds for wings. At the same time, the reinforcing foams shall be able to withstand the shearing forces arising as a result of the flexing/bending.

An essential criterion for a reinforcing foam in blades or wings is low weight. Blade tips can reach circumferential speeds on the order of 100 m/s, which produces large radial forces. To minimize these, it is desirable for the reinforcing foam to have a very low weight.

It is an object of the present invention to provide a foam having very good mechanical properties, such as high compressive strength and modulus, and also tensile and flexural strength and moduli, and also a high shear resistance coupled with high elasticity and low density. The foam shall further have a high flexural modulus of elasticity and a high thermal stability and the manufacture of the foam shall be simple and the recycling and/or disposal shall be possible in an environmentally friendly manner.

We have found that this object is achieved by a reinforced polyurethane foam having a density of above 50 to 300 g/L, a density-independent compressive strength of above 7.5*10⁻⁴ MPa (L/g)^{1.6}, a density-independent compressive modulus of elasticity of above 1.7*10⁻² MPa (L/g)^{1.7}, a tensile strength of above 6.4*10⁻⁴ MPa (L/g)^{1.6}, a tensile modulus of elasticity of above 2.4*10⁻² MPa (L/g)^{1.7}, preferably 3.0*10⁻²*10⁻² MPa (L/g)^{1.7}, a flexural strength of above 1.25*10⁻³ MPa (L/g)^{1.6}, preferably 1.50*10⁻³ MPa (L/g)^{1.6} and a flexural modulus of elasticity of above 1.75*10⁻² MPa (L/g)^{1.7}, obtainable by mixing (a) polyisocyanates with (b) compounds having isocyanate-reactive groups, (c) blowing agent comprising water, and optionally (d) catalyst and (e) further additives to form a reaction mixture and curing the reaction mixture, wherein the reaction mixture to be cured comprises from 1% to 40% by weight of hollow microspheres and/or is applied to a porous reinforcing agent (f) capable of forming two-dimensional or three-dimensional networks in the polyurethane foam, the compounds having isocyanate-reactive groups (b) comprise polyetherols (b1), polyesterols (b2), chain extenders (b3) and optionally crosslinkers (b4) and aromatic polyether diols (b5), and said component (b) comprises a fraction of polyesterols (b2), chain extenders (b3) and aromatic polyether diols (b5) that is equal to at least 50% by weight, based on the total weight of said component (b).

Compressive and tensile values herein are measured both perpendicularly and parallel to the direction of foaming and are always reported/specified as space averages computed as per (x*y*z)^{1/3}. Flexural values and shear strength are always measured and reported/specified perpendicularly to the direction of foaming.

A reinforced polyurethane foam herein is a reinforced polyurethane foam wherein the hollow microspheres and/or the reinforcing agent (f) is or are present in the form of plies or in the form of plies and hollow microspheres. Alternatively, there may be a three-dimensional reinforcing agent which forms a network, optionally in combination with hollow microspheres. Preferably, the reinforcing agent is in the form of at least two plies which form a homogeneous distribution in the foam and are preferably perpendicular to the direction of foaming. “Homogeneous distribution” in this connection is to be understood as meaning that the maximum separation between two adjacent plies, or between the upper ply and the top side of the foam, or between the lower ply and the bottom side of the foam will not differ from the minimum separation between two plies, or between the upper ply and the top side of the foam, or between the lower ply and the bottom side of the foam, respectively, by more than a factor of 4, preferably by more than a factor of 2 and more particularly by more than a factor of 1.5.

The reinforcing agents (f) can consist for example of known glass fibers, aramid fibers, carbon fibers or polymeric fibers, such as glass fiber mats for example. The reinforcing materials may also consist of a combination of these materials of construction. For instance, a three-dimensional reinforcing agent can consist of two glass fiber mats which are joined together by polyamide fibers.

The ply-shaped reinforcing agent is used in amounts of at least 3.5 to 35 kg per m³ of foam, depending on foam density and desired reinforcing effect. This implies, for example, one ply of a reinforcing agent having a density of 450 g/m² in the case of a foam body having an area of 1 m², a height of 3 cm and a foam density of 100 g/L. A ply-shaped reinforcing agent may also have a three-dimensional extent. Combinations of hollow microspheres, ply-shaped reinforcing agent and/or three-dimensional reinforcing agent are also possible.

The proportion of reinforcing agent (f) and/or hollow microspheres is preferably in the range from 1 to 40 percent by weight and more particularly 2-20 percent by weight, based on the total weight of the rigid polyurethane foam including reinforcing agent (f) and/or hollow microspheres.

The reinforced rigid foam used in the polyurethane composite system of the present invention has a DIN 53421/DIN EN ISO 604 density-independent compressive strength of above 7.5*10⁻⁴ MPa (L/g)^{1.6}, a density-independent compressive modulus of elasticity of above 1.7*10⁻² MPa (L/g)^{1.7}, a DIN 53292/DIN EN ISO 527-1 density-independent tensile strength of above 6.4*10⁻⁴ MPa (L/g)^{1.6}, a density-independent tensile modulus of elasticity of above 2.4*10⁻² MPa (L/g)^{1.7} preferably 3.0*10⁻² MPa (L/g)^{1.7}, a DIN 53423 density-independent flexural strength of above 1.25*10⁻³ MPa (L/g)^{1.6}, preferably 1.50*10⁻³ MPa (L/g)^{1.6} and a density-independent flexural modulus of elasticity of above 1.75*10⁻² MPa (L/g)^{1.7}. The reinforced polyurethane rigid foam of the present invention preferably further has a density-independent shear strength of above 3.8*10⁻⁴ MPa (L/g)^{1.6} and more preferably 5.5*10⁻⁴ MPa (L/g)^{1.6}. Density-independent compressive strength was computed as per compressive strength*(density)^{-1.6} and the density-independent compressive E-modulus was computed as per compressive E-modulus*(density)^{-1.7}. For a reinforced rigid foam used in the polyurethane composite system of the present invention this means, for a foam density of 100 g/L, a compressive strength of at least 1.19 MPa and preferably at least 1.2 MPa and a compressive E-modulus of at least 42.7 MPa and preferably at least 44 MPa, a tensile strength of at least 1.0 MPa and a tensile E-modulus of at least 60.3 MPa and preferably at least 75 MPa, a flexural strength of at least 1.98 MPa and preferably at least 2.38 MPa and a flexural E-modulus of at least 44 MPa. The density of the reinforced polyurethane rigid foam used according to the present invention is above 50 g/L to 300 g/L, preferably in the range from 80 g/L to 250 g/L and more preferably in the range from 100 g/L to 220 g/L.

The reinforced rigid foams of the present invention preferably further have a softening temperature of more than 100° C., more preferably more than 120° C. and even more preferably more than 140° C. The softening temperature is the temperature at which the polyurethane rigid foam of the present invention exhibits its maximum loss modulus G″ in dynamic mechanical analysis (DMA) as per DIN EN ISO 6721-2. A high softening temperature makes it possible to produce the composite elements of the present invention at a higher temperature without structural changes in the foam which lead to dramatically compromised mechanical properties.

As isocyanates (a), it is possible to use all customary aliphatic, cycloaliphatic and preferably aromatic di- and/or polyisocyanates which have a viscosity of less than 600 mPas, preferably less than 500 mPas and more preferably less than 350 mPas, when measured at 25° C. Particular preference for use as isocyanates is given to toluene diisocyanate (TDI), diphenylmethane diisocyanate (MDI) and mixtures of diphenylmethane diisocyanate and polymeric diphenylmethane diisocyanate (PMDI). Mixtures of diphenylmethane diisocyanate and PMDI are used in particular. These particularly preferred isocyanates may be wholly or partly modified with uretdione, carbamate, isocyanurate, carbodiimide, allophanate and preferably urethane groups.

Useful isocyanates (a) further include prepolymers and also mixtures of the above-described isocyanates and prepolymers. These prepolymers are obtained from the above-described isocyanates and also the hereinbelow described polyethers, polyesters or both, and have an NCO content in the range from 14% to 32% by weight and preferably in the range from 22% to 30% by weight.

As compounds having isocyanate-reactive groups (b) there can be used any compound that has at least two isocyanate-reactive groups, such as OH, SH, NH and carbon-acid groups. This component (b) herein includes polyetherols (b1), polyesterols (b2), chain extenders (b3) and optionally crosslinkers (b4) and/or aromatic polyether diols (b5), although this is to be understood as meaning that crosslinkers (b4) and aromatic polyether diols (b5) can be included independently of each other.

The polyetherols (b1) are obtained via known methods, for example by an anionic polymerization of alkylene oxides in the presence of catalysts which is initiated with at least one starter molecule comprising from 2 to 8, and preferably from 2 to 6 reactive hydrogen atoms in bound form. Useful catalysts include alkali metal hydroxides, such as sodium hydroxide or potassium hydroxide, or alkali metal alkoxides, such as sodium methoxide, sodium ethoxide, potassium ethoxide or potassium isopropoxide, or—in the case of a cationic polymerization—Lewis acids, such as antimony pentachloride, boron trifluoride etherate or fuller's earth. Useful catalysts further include double metal cyanide compounds, so-called DMC catalysts, and also amine-based catalysts.

The alkylene oxides used preferably comprise one or more compounds having from 2 to 4 carbon atoms in the alkylene radical, such as tetrahydrofuran, 1,3-propylene oxide, 1,2-butylene oxide, or 2,3-butylene oxide, each alone or in the form of mixtures, and preferably ethylene oxide and/or 1,2-propylene oxide.

Useful starter molecules include ethylene glycol, diethylene glycol, propylene glycol, dipropylene glycol, glycerol, trimethylolpropane, pentaerythritol, sugar derivatives, such as sucrose, hexitol derivatives, such as sorbitol, methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and also other di- or polyhydric alcohols or mono- or polyfunctional amines.

Preferably, the polyetherols (b1) comprise at least one polyetherol (b1a) having an average functionality of 3.5 or greater, preferably in the range from 3.6 to 8 and more particularly in the range from 3.8 to 6, and a viscosity at 25° C. of 15 000 mPas or less, preferably 10 000 mPas or less. The molecular weight is preferably in a range of 300-900 g/mol, more preferably 400-800 g/mol and more particularly 450-750 g/mol. The proportion of the overall weight of component (b) which is contributed by the polyetherols (b1a) is preferably in the range from 20% to 50% by weight and more preferably in the range from 25% to 40% by weight. The polyetherol (b1) may also comprise from 0% to 20% by weight and preferably from 1% to 10% by weight of polyetherol (b1b) having a molecular weight of above 300 to 3000 g/mol, preferably in the range from 400 to 2500 g/mol and more particularly in the range from 400 to 1000 g/mol. The polyetherols (b1b) preferably have an average functionality in the range from 1.8 to 3.0 and more preferably in the range from 1.95 to 2.2 and preferably have secondary OH groups.

Useful polyester alcohols (b2) are usually obtained by condensation of polyfunctional alcohols having from 2 to 12 carbon atoms, such as ethylene glycol, diethylene glycol, butanediol, trimethylolpropane, glycerol or pentaerythritol, with polyfunctional carboxylic acids having from 2 to 12 carbon atoms, examples being succinic acid, glutaric acid, adipic acid, suberic acid, azelaic acid, sebacic acid, decanedicarboxylic acid, maleic acid, fumaric acid, phthalic acid, isophthalic acid, terephthalic acid, the isomers of naphthalenedicarboxylic acids or the anhydrides of the acids mentioned. Preference is given to using aromatic diacids, such as phthalic acid, isophthalic acid and/or terephthalic acid and also their anhydrides as acid component and ethylene glycol, diethylene glycol, 1,4-butanediol and/or glycerol as alcohol component.

In a further embodiment, the polyester alcohols (b2) can be obtained by replacing the diacids or anhydrides thereof by corresponding monomeric esters, such as dimethyl terephthalate for example, or polymeric esters, such as polyethylene terephthalate (PET) for example.

Useful starting materials for preparing these polyesters further include hydrophobic substances. The hydrophobic substances comprise water-insoluble substances comprising an apolar organic radical and also having at least one reactive group selected from the group consisting of hydroxyl, carboxylic acid, carboxylic ester or mixtures thereof. The equivalent weight of the hydrophobic materials is preferably between 130 and 1000 g/mol. Fatty acids can be used for example, such as stearic acid, oleic acid, palmitic acid, lauric acid or linoleic acid, and also fats and oils, for example castor oil, maize oil, sunflower oil, soyabean oil, coconut oil, olive oil or tall oil. When polyesters comprise hydrophobic substances, the proportion of the overall monomer content of the polyester alcohol that is accounted for by the hydrophobic substances is preferably in the range from 1 to 30 mol % and more preferably in the range from 4 to 15 mol %. These polyesters comprising hydrophobic substances are hereinafter referred to as hydrophobic polyesters. The proportion of hydrophobic polyesters, based on the total weight of the polyesterols (b2), is preferably in the range from 0% to 80% by weight and more preferably in the range from 5% to 60% by weight.

Useful polyesterols (b2) preferably have an average functionality in the range from 1.5 to 5, more preferably in the range from 1.8 to 3.5 and even more preferably in the range from 1.9 to 2.2 and viscosities at 25° C. of preferably below 3000 mPas and more preferably below 2500 mPas. The molecular weight is preferably in the range from 290 to 1000 g/mol, more preferably in the range from 320 to 800 g/mol and even more preferably in the range from 340 to 650 g/mol.

In a preferred embodiment, the component (b) comprises at least 50% by weight, based on the total weight of component (b), of polyesterols (b2). It is very particularly preferable for the polyesters (b2) to comprise hydrophobic polyesters in this case.

The compound having isocyanate-reactive groups (b) further comprises chain-extending agents (b3) and/or crosslinking agents (b4). The chain-extending and/or crosslinking agents used are more particularly di- or trifunctional amines and alcohols, more particularly diols, triols or both, each with molecular weights less than 300 g/mol, preferably in the range from 60 to 300 g/mol and more preferably in the range from 60 to 250 g/mol. It is the difunctional compounds which are known as chain extenders (b3) and the tri- or higher-functional compounds which are known as crosslinkers (b4). Possible examples include aliphatic, cycloaliphatic and/or aromatic diols having from 2 to 14 and preferably from 2 to 10 carbon atoms, such as ethylene glycol, 1,2-propanediol, 1,3-propanediol, 1,2-pentanediol, 1,3-pentanediol, 1,10-decanediol, 1,2-dihydroxycyclohexane, 1,3-dihydroxycyclohexane, 1,4-dihydroxycyclohexane, diethylene glycol, triethylene glycol, dipropylene glycol, tripropylene glycol, 1,4-butanediol, 1,6-hexanediol and bis(2-hydroxyethyl)hydroquinone, triols and higher polyols, such as 1,2,4-trihydroxycyclohexane, 1,3,5-trihydroxycyclohexane, glycerol and trimethylolpropane, N,N,N′,N′-tetrakis(2-hydroxypropyl)ethylenediamine, and low molecular weight hydroxyl-containing polyalkylene oxides based on ethylene oxide and/or 1,2-propylene oxide and the aforementioned diols and/or triols as starter molecules.

The proportion of the total weight of component (b) that is accounted for by the crosslinkers (b4) is preferably in the range from 0% to 40% by weight, and more preferably in the range from 1% to 30% by weight. The production of foams for the insulation of liquefied natural gas tanks in particular preferably utilizes from 0.5% to 8% by weight and more particularly from 1% to 5% by weight of crosslinker, and this crosslinker is preferably glycerol.

The chain extender (b3) has on average at least 30%, preferably at least 40%, more preferably at least 50% and even more preferably at least 60% of secondary OH groups. The chain extender (b3) may comprise individual compounds or mixtures. The chain extender (b3) preferably comprises monopropylene glycol, dipropylene glycol, tripropylene glycol and/or 2,3-butanediol alone or optionally mixed with each or one another or with further chain extenders. In a particularly preferred embodiment, dipropylene glycol is used together with a second chain extender, for example 2,3-butanediol, monopropylene glycol or diethylene glycol, as chain extender (b3). Crosslinking agent (b4) preferably comprises 1,2,4-trihydroxycyclohexane, 1,3,5-trihydroxycyclohexane, glycerol, N,N,N′,N′-tetrakis(2-hydroxypropyl)ethylenediamine and/or trimethylolpropane. Preference for use as crosslinking agent is given to glycerol or N,N,N′,N′-tetrakis(2-hydroxypropyl)ethylenediamine, more particularly glycerol.

The aromatic polyether diol (b5) is an alkoxylation product of an aromatic diol, preferably bisphenol A, and ethylene oxide and/or propylene oxide. The aromatic polyether diol (b5) thus has a preferred functionality of 2 and a number average molecular weight of above 300 g/mol and preferably of above 300 to 600 g/mol.

The component (b) may include from 5% to 50% by weight of chain extender (b3) for example. The amount of chain extender (b3) included in component (b) is preferably in the range from 8% to 50%, and more preferably in the range from 10% to 30% by weight.

It is essential to the present invention for component (b) to comprise a proportion of polyesterols (b2), chain extenders (b3) and aromatic polyetherols (b5) which is equal to at least 50% by weight, preferably in the range from 50% to 80% by weight, more preferably in the range from 55% to 75% by weight and even more preferably in the range from 60% to 70% by weight, based on the total weight of component (b). Components (b1) to (b5) can each comprise individual compounds or mixtures, in which case each of the compounds used comes within the definition of (b1) to (b5).

Preferably, component (b) includes at least 50% by weight, more preferably at least from 55% to 85% and even more preferably from 60% to 75% by weight of compounds having two or three isocyanate-reactive groups. These compounds having two or three isocyanate-reactive groups preferably have a molecular weight of below 2500 g/mol, more preferably below 1000 g/mol, and more particularly below 800 g/mol. The number average molecular weight of these compounds is preferably not more than 500 g/mol, more preferably in the range from 150 to 450 g/mol and more particularly in the range from 250 to 450 g/mol.

The proportion contributed by the polyetherols (b1), (b2), (b3) and optionally (b4) and (b5) to the compound having isocyanate-reactive groups (b) is preferably at least 80% by weight, more preferably at least 90% by weight and more particularly 100% by weight, based on the total weight of compound having isocyanate-reactive groups (b).

The molar overall functionality of component (b) is preferably less than 3.0, more preferably between 2.0 and 2.9 and even more preferably between 2.4 and 2.8. The average OH number of component (b) is preferably greater than 300 mg KOH/g, more preferably between 350 and 1000 mg KOH/g and even more preferably between 400 and 600 mg KOH/g.

When isocyanate prepolymers are used as isocyanates (a), the level of compounds having isocyanate-reactive groups (b) is reckoned inclusive of the compounds having isocyanate-reactive groups (b) that were used in preparing the isocyanate prepolymers.

Blowing agent (c) comprises blowing agent comprising water. Water can be used as sole blowing agent or in combination with further blowing agents. The water content of blowing agent (c) is preferably greater than 40% by weight, more preferably greater than 60% by weight and even more preferably greater than 80% by weight, based on the total weight of blowing agent (c). More particularly, water is used as sole blowing agent. When, in addition to water, further blowing agents are used, chlorofluorocarbons, hydrofluorocarbons, hydrocarbons, acids and liquid/dissolved carbon dioxide may be used for example. Preferably, blowing agents (c) comprise less than 50% by weight, preferably less than 20% by weight, more preferably less than 10% by weight and even more preferably 0% by weight, based on the total weight of blowing agent (c), of chlorofluorocarbons, hydrofluorocarbons and/or hydrocarbons. A further embodiment may comprise using a mixture of water and formic acid and/or carbon dioxide as blowing agent (c). To simplify dispersion of the blowing agent in the polyol component, the blowing agent (c) may be admixed with polar compounds, such as dipropylene glycol.

The blowing agents (c) are used in such an amount that the density of the rigid polyurethane foam formed by reaction of components (a) to (e) is inclusive of reinforcing agent (f) and/or hollow microspheres, in the range of above 50 g/L to 300 g/L, preferably in the range from 80 g/L to 250 g/L and more preferably in the range from 100 g/L to 220 g/L. When the rigid polyurethane foams of the present invention are reinforced using hollow glass spheres only, the blowing agents (c) are used in such an amount that the density of the rigid polyurethane foam formed by reaction of components (a) to (e) is inclusive of hollow microspheres in the range above 30 g/L to 250 g/L, preferably in the range from 60 g/L to below 160 g/L and more preferably in the range from 80 g/L to less than 110 g/L.

Catalyst (d) may be any compound that speeds the isocyanate-water reaction or the isocyanate-polyol reaction. Such compounds are known and described for example in “Kunststoffhandbuch, volume 7, Polyurethane”, Carl Hanser Verlag, 3rd edition 1993, chapter 3.4.1. These comprise amine-based catalysts and catalysts based on organometallic compounds.

Useful catalysts based on organometallic compounds include for example organotin compounds, such as tin(II) salts of organic carboxylic acids, such as tin(II) acetate, tin(II) octoate, tin(II) ethylhexanoate and tin(II) laurate and the dialkyltin(IV) salts of organic carboxylic acids, such as dibutyltin diacetate, dibutyltin dilaurate, dibutyltin maleate and dioctyltin diacetate, and also bismuth carboxylates such as bismuth(III) neodecanoate, bismuth 2-ethylhexanoate and bismuth octanoate or alkali metal salts of carboxylic acids, such as potassium acetate or potassium formate.

Catalyst (d) is preferably a mixture comprising at least one tertiary amine. These tertiary amines usually comprise compounds which can also bear isocyanate-reactive groups, such as OH, NH or NH₂ groups. Some of the most frequently used catalysts are bis(2-dimethylaminoethyl)ether, N,N,N,N,N-pentamethyldiethylenetriamine, N,N,N-triethylaminoethoxyethanol, dimethylcyclohexylamine, dimethylbenzylamine, triethylamine, triethylenediamine, pentamethyldipropylenetriamine, dimethylethanolamine, N-methylimidazole, N-ethylimidazole, tetramethylhexamethylenediamine, tris(dimethylaminopropyl)hexahydrotriazine, dimethylaminopropylamine, N-ethylmorpholine, diazabicycloundecene and diazabicyclononene. When low migration of catalysts out of the foams of the present invention and/or low emission of VOC compounds is desired, incorporable catalysts can also be used. And it is also possible to dispense with catalysts entirely.

The hollow microspheres are preferably selected from the group consisting of hollow thermoplastic microspheres, hollow glass microspheres and hollow microspheres made of glass ceramic. Examples of hollow microspheres made of glass and glass ceramic are the commercially available hollow microspheres Z-Lite W-1000 from Zeelan Industries and Scotchlite from 3M and also CEL 300 and 650 from PQ Corporation, respectively.

The use of hollow thermoplastic microspheres is preferred. The hollow thermoplastic microspheres used herein are known to a person skilled in the art and are commercially available under the product name of Expancel (Akzo Nobel) at Schonox GmbH (Essen Germany). In the case of the hollow microspheres concerned here, their shell consists of a copolymer based on acrylonitrile and their void space is filled with a blowing gas. In general, the unexpanded hollow microspheres have a diameter in the range from 6 to 45 μm and a density in the range from 1000 to 1300 g/L. The blowing gases typically comprise volatile hydrocarbons such as, for example, butane, pentane, hexane, heptane, isobutene, isopentane, neopentane, cyclopropane, cyclobutane and cyclopropane. If necessary, these hollow spheres can also be manufactured and produced with any other low-boiling solvents. When the hollow microspheres are heated, the gas raises the internal pressure, the layer of polymer softens and the expansion process starts. After complete expansion, the hollow microsphere will have increased its diameter by three to four times the original diameter and its volume by more than forty times its original volume. The density after expansion is 30 g/L. The expansion temperatures are generally in the range between 80-190° C. After cooling, the thermoplastic material solidifies again, preserving the expanded volume.

The porous reinforcing agent (f), capable of forming ply-shaped, i.e., two-dimensional, or three-dimensional networks in the polyurethane foam can be any material that will imbue the rigid polyurethane foam with even higher mechanical stability and is present in the rigid polyurethane foam of the present invention in the form of two-dimensional or three-dimensional networks. An example of a reinforcing agent forming a two-dimensional network is a fiber mat, for example a glass fiber mat, while an example of a three-dimensional reinforcing agent is a plurality of mutually crosslinked fiber mats or rovings which are preferably likewise mutually crosslinked. For a reinforcing agent to qualify as porous within the context of the present invention the reaction mixture for producing the rigid polyurethane foam has to be capable of penetrating into and through the reinforcing agent while wetting it completely. The materials forming the three-dimensional reinforcing agent, for example, rovings or ribbons/tapes/ligaments, are preferably joined to one another, for example by interlooping or interlinking. To form three-dimensional reinforcing agents, two or more two-dimensional reinforcing agents, such as fiber mats, are also to be linked together. Furthermore, twisted or braided strands of fiber, such as fiber plaits, can be used as three-dimensional reinforcing agents.

Such porous reinforcing agents (f) capable of forming ply-shaped or three-dimensional networks in the polyurethane foam are for example wovens or knits based on fibers. Examples of porous, two-dimensional reinforcing agents which are preferably used are fiber mats, for example glass fiber, aramid fiber or carbon fiber mats or mats of fibers composed of plastic or ribbons/tapes/ligaments composed of these materials, preferably glass fiber mats, for example Unifilo® U801 or U809 from Owens Corning Vetrotex. Glass fiber roving mats can also be used. The proportion of reinforcing agent (f) is preferably in the range from 1 to 40, and more preferably in the range from 2 to 20 percent by weight, based on the total weight of components (a) to (f).

Possible further additives (e) include flame retardants, plasticizers, foam stabilizers, further fillers and other addition agents, such as antioxidants. Preferably, at least flame retardants or plasticizers are used.

Flame retardants used can be the flame retardants generally known from the prior art. Suitable flame retardants include for example brominated ethers (Ixol B 251), brominated alcohols, such as dibromoneopentyl alcohol, tribromoneopentyl alcohol and PHT-4-diol, and also chlorinated phosphates, e.g., tris(2-chloroethyl)phosphate, tris(2-chloroisopropyl)phosphate (TCPP), tris(1,3-dichloroisopropyl)phosphate, tris(2,3-dibromopropyl)phosphate and tetrakis(2-chloroethyl)ethylene diphosphate, or mixtures thereof.

In addition to the aforementioned halogen-substituted phosphates, inorganic flame retardants, such as red phosphorus, preparations comprising red phosphorus, expandable graphite, aluminum oxide hydrate, antimony trioxide, arsenic oxide, ammonium polyphosphate and calcium sulfate or cyanuric acid derivatives, such as melamine, or mixtures of at least two flame retardants, such as ammonium polyphosphates and melamine, and also optionally starch, can also be used for rendering the polyurethane rigid foams produced according to the present invention flame resistant.

Diethyl ethanephosphonate (DEEP), triethyl phosphate (TEP), dimethyl propylphosphonate (DMPP), diphenyl cresyl phosphate (DPC) and others can be used as further liquid halogen-free flame retardants.

Flame retardants herein are preferably used in an amount ranging from 0% to 25% based on the total weight of components (b) to (e).

Useful plasticizers include for example esters of polybasic, preferably dibasic, carboxylic acids with monohydric alcohols. The acid component of such esters is derivable for example from succinic acid, isophthalic acid, terephthalic acid, trimellitic acid, citric acid, phthalic anhydride, tetra- and/or hexahydrophthalic anhydride, endomethylenetetrahydrophthalic anhydride, glutaric anhydride, maleic anhydride, fumaric acid and/or dimeric and/or trimeric fatty acids such as oleic acid, optionally in admixture with monomeric fatty acids. The alcohol component of such esters is derivable for example from branched and/or unbranched aliphatic alcohols having from 1 to 20 carbon atoms, such as methanol, ethanol, propanol, isopropanol, n-butanol, sec-butanol, tert-butanol, the various isomers of pentyl alcohol, of hexyl alcohol, of octyl alcohol (e.g., 2-ethylhexanol), of nonyl alcohol, of decyl alcohol, of lauryl alcohol, of myristyl alcohol, of cetyl alcohol, of stearyl alcohol and/or from naturally occurring fatty and waxy alcohols or fatty and waxy alcohols obtainable by hydrogenation of naturally occurring carboxylic acids. As alcohol component, it is also possible to use cycloaliphatic and/or aromatic hydroxy compounds, for example cyclohexanol and its homologs, phenol, cresol, thymol, carvacrol, benzyl alcohol and/or phenylethanol. Useful plasticizers further include esters of monobasic carboxylic acids with dihydric alcohols, such as texanol ester alcohols, for example 2,2,4-trimethyl-1,3-pentanediol diisobutyrate (TXIB) or 2,2,4-trimethyl-1,3-pentanediol dibenzoate; diesters formed from oligoalkylene glycols and alkyl carboxylic acids, for example triethylene glycol dihexanoate or tetraethylene glycol diheptanoate and analogous compounds.

Useful plasticizers further include esters of the abovementioned alcohols with phosphoric acid. Optionally, phosphoric esters of halogenated alcohols, such as trichloroethyl phosphate for example, may also be used. In the latter case, a flame-retardant effect is obtainable as well as the plasticizer effect. It will be appreciated that it is also possible to use mixed esters of the abovementioned alcohols and carboxylic acids.

The plasticizers may also be so-called polymeric plasticizers, for example polyesters of adipic, sebacic and/or phthalic acid(s).

It is further possible to use alkyl sulfonic esters of phenol, e.g., phenyl paraffinsulfonate, and aromatic sulfonamides, e.g., ethyltoluenesulfonamide, as plasticizers. Similarly, polyethers, for example triethylene glycol dimethyl ether are useful as plasticizers.

The amount of plasticizer used is preferably in the range from 0.1% to 15% and more preferably in the range from 0.5% to 10% by weight, based on the total weight of components b) to e). Having plasticizer is a way to further improve the mechanical properties of the rigid polyurethane foam at low temperatures in particular.

Foam stabilizers promote the formation of a regular cellular structure during foam formation. Examples include silicone-containing foam stabilizers, such as siloxane-oxyalkylene copolymers and other organopolysiloxanes. Also alkoxylation products of fatty alcohols, oxo process alcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol, and also alkoxylation products of condensation products formed from formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and also formaldehyde and bisphenol A, or mixtures of two or more of these foam stabilizers.

The amount of foam stabilizer used is preferably in the range from 0.5% to 4% and more preferably in the range from 1% to 3% by weight, based on the total weight of components (b) to (e).

Further fillers, in particular reinforcing fillers, are customary organic and inorganic fillers known per se. Specific examples are inorganic fillers such as silicatic minerals, for example sheet silicates such as antigorite, serpentine, hornblendes, amphiboles, chrysotile, talc; metal oxides, such as kaolin, aluminas, titanias and iron oxides, metal salts such as chalk, barite and inorganic pigments, such as cadmium sulfide, zinc sulfide and also glass and others. Preference is given to using kaolin (china clay), aluminum silicate and coprecipitates formed from barium sulfate and aluminum silicate, and also natural and synthetic fibrous minerals such as wollastonite, metal fibers and in particular glass fibers of differing length, which may optionally be sized. Organic fillers include for example carbon, melamine, rosin, cyclopentadienyl resins and graft polymers and also cellulose fibers, polyamide fibers, polyacrylonitrile fibers, polyurethane fibers, polyester fibers based on aromatic and/or aliphatic dicarboxylic esters, and more particularly carbon fibers.

The organic and inorganic fillers can be used singly or as mixtures, and are advantageously incorporated in the reaction mixture in amounts ranging from 0% to 30% by weight and preferably from 1% to 15% by weight based on the weight of components (a) to (e). For the purposes of the present invention, the aforementioned reinforcing agents (f) and/or hollow microspheres are not regarded as fillers and are not included under component (e) in reckoning the proportions.

The present invention further provides a process for producing a reinforced polyurethane foam comprising mixing (a) polyisocyanates with (b) compounds having isocyanate-reactive groups, (c) blowing agent comprising water, (d) a catalyst mixture and optionally hollow microspheres and (e) further additives, to form a reaction mixture, applying the reaction mixture to at least one reinforcing agent (f) and curing the reaction mixture, wherein the compounds having isocyanate-reactive groups (b) comprise polyetherols (b1), polyesterols (b2), chain extenders (b3) and optionally crosslinkers (b4) and aromatic polyether diols (b5), and said component (b) comprises a fraction of polyesterols (b2) and chain extenders (b3) that is equal to at least 50% by weight, based on the total weight of said component (b). The process of the present invention utilizes the feedstocks described above. The polyurethane reaction mixture preferably penetrates into the reinforcing agent and wets it uniformly. The foaming polyurethane reaction mixture then leads to a homogeneous distribution of the reinforcing agent in the foam wherein the plies of a ply-shaped reinforcing agent are oriented perpendicularly to the direction of foaming for example.

The rigid polyurethane foam of the present invention is preferably produced in a continuous manner on a belt. For this purpose, it is preferable to mix components (b) to (d) and optionally hollow glass microspheres and (e) together to form a polyol component. These are then preferably mixed with the isocyanate component (a) in a low pressure mixing device, a high pressure mixing device at reduced pressure of below 100 bar or a high pressure machine. Alternatively, components (a) to (d) and optionally hollow microspheres and (e) can each be introduced individually into the mixing device. The reaction mixture thus obtained is then placed on the reinforcing agent (f), preferably the glass fiber mats, which are preferably continuously unrolled onto the belt from multiple (for example 4-10, preferably 5, 6 or 7) drums and form a corresponding number of plies on the belt. The foam obtained is then preferably cured on the belt to such an extent that it can be cut into pieces without damage. This can take place at elevated temperatures, for example during passage through an oven. The pieces of foam obtained are then preferably further stored in order that full mechanical strength may be acquired.

Another way to produce the rigid polyurethane foam of the present invention is to batch foam the reaction mixtures in a mold. The reinforcing agent of the present invention can in this case be introduced into the mold before or at the same time as the reaction mixture.

The rigid polyurethane foam obtained is then cut into the shape required for further processing.

Isocyanates (a) and compounds having isocyanate-reactive groups (b), blowing agent comprising water (c) and optionally catalysts (d) and further additives (e) are preferably reacted in such amounts that the isocyanate index is in the range from 100 to 400, preferably in the range from 100 to 200 and more preferably in the range from 100 to 150.

The isocyanate index for the purposes of the present invention is the stoichiometric ratio of isocyanate groups to isocyanate-reactive groups, multiplied by 100. An isocyanate-reactive group is any isocyanate-reactive group present in the reaction mixture, including chemical blowing agents, but not the isocyanate group itself.

It is particularly advantageous that the reaction mixtures of the present invention are quick to penetrate into the reinforcing agents (f), which is beneficial to achieving a uniform distribution of the reinforcing agents (f) in the rigid polyurethane foam obtained. Another advantage is the long cream time of the reaction mixtures of the present invention coupled with a short reaction time.

The reinforced polyurethane foam of the present invention exhibits excellent mechanical properties, such as high compressive strength and modulus, and also tensile and flexural strength and moduli, and also a high shear strength coupled with high elasticity and low density. The reinforced polyurethane foam of the present invention further has a high flexural modulus of elasticity and a high thermal stability and is obtainable in a simple and environmentally friendly manner. Environmentally friendly disposal of polyurethane foams is also possible. For instance, a polyurethane foam can be disassembled, by glycolysis for example, back into its starting compounds, which can be reused as raw materials.

The foam of the present invention is preferably used as a foam in a structural sandwich component, the outside layers of which preferably consist of fiber-reinforced resin. The resin used can be for example a known epoxy, polyester or polyurethane resin, which is laminated onto the polyurethane foam in a conventional manner. Alternatively, the polyurethane foam of the present invention can also be adhered to such an outside layer or be produced thereon. The fiber-reinforced resin can be used as a mold or part of a mold. In addition to fiber-reinforced resins, the outside layers can also consist of thermoplastic materials, woodbase materials or metal. The outside layer may enclose part of the foam or the entire foam. When the foam is enclosed by an outside layer, the foam of the present invention can fill part of or the entire interior of the structural sandwich component. When only part of the structural sandwich component is filled by the foam of the present invention, this foam preferably forms a reinforcing ply in the structural sandwich component in which the remaining space in the interior of the structural sandwich component preferably constitutes unfilled gas space.

The reinforced polyurethane foam of the present invention can accordingly be used as a reinforcing foam in blades, for example rotor blades, and wings of aircraft, more particularly as a core foam. A core foam is a reinforcing ply in a blade or wing, which either fills out the entire core or, in the case of hollow blades, forms an interior, reinforcing ply which is positioned underneath the surface material, which consists of glass fiber resins for example. A structural sandwich component according to the present invention is preferably used as a blade or wing. A further possible use for structural sandwich component is as a boat's hull or as a load-bearing stiff areal element.

The reinforced polyurethane foam of the present invention can further be used as an insulation material for liquefied natural gas tanks, particularly onboard ships.

The examples which follow illustrate the invention.

Production of Reinforced Polyurethane Rigid Foams (Variant 1):

TABLE 1

| | 1 | 2 | V1 | V2 | V3 |
|---|---|---|---|---|---|
| polyether 1 | | | 40 | 40 | 40 |
| polyether 2 | | | 25 | 25 | 25 |
| polyether 3 | 28 | 28 | | | |
| polyether 4 | 20 | 20 | | | |
| polyester 1 | 37 | 17 | 25 | 25 | 25 |
| chain extender 1 | 12 | 12 | 10 | 10 | 10 |
| aromatic diol | | 20 | | | |
| water | 2 | 2 | 1.0 | 1.0 | 1.0 |
| catalyst 1 | | | 0.08 | 0.08 | 0.08 |
| stabilizer 1 | 1 | 1 | 1.5 | 1.5 | 1.5 |
| isocyanate 1 | | | 126 | 126 | 126 |
| isocyanate 2 | 142 | 152 | | | |
| plies of glass fiber mats | 0 | 0 | 0 | 7 | |
| hollow glass spheres | 17 | 8.2 | | | 8.0 |
| foam density in g/L | 100 | 100 | 100 | 112 | 100 |
| compressive strength in MPa | 1.42 | 1.39 | 0.91 | 1.15 | 0.84 |
| compressive E-modulus in MPa | 52.1 | 43.6 | 24.8 | 43.1 | 23.4 |
| tensile strength in MPa | 1.11 | 1.16 | n.d. | n.d. | n.d. |
| tensile E-modulus in MPa | 63.4 | 62.4 | n.d. | n.d. | n.d. |
| 3-point flexural strength in MPa | 2.03 | 2.11 | 1.62 | 1.91 | n.d. |
| 3-point flexural E-modulus in | 55.1 | 51.2 | n.d. | n.d. | n.d. |
| MPa | | | | | |
| shear strength in MPa | 0.62 | 0.69 | 0.83 | 0.79 | 0.41 |

The following materials were used:
Polyether 1: sucrose/glycerol-based polypropylene oxide, Fn = 4.5, number average molecular weight = 515 g/mol, viscosity = 8000 mPa*s at 25° C.
Polyether 2: polypropylene glycol, Fn = 2, number average molecular weight = 1100 g/mol, viscosity = 150 MPa*s at 25° C.
Polyether 3: ethylenediamine-based polypropylene oxide, Fn = 3.9, number average molecular weight = 470 g/mol, viscosity = 4975 MPa*s at 25° C.
Polyether 4: ethylenediamine-based polypropylene oxide, Fn = 4.0, number average molecular weight = 300 g/mol
Polyether 4: sorbitol-based polypropylene oxide, OH number = 490 mgKOH/g (Lupranol ® 3422 from BASF SE)
Polyester 1: phthalic anhydride/diethylene glycol-based, Fn = 2, number average molecular weight = 360 g/mol
Polyester 2: aromatic polyester polyol, OH number = 240 mgKOH/g (Lupraphen ® 8007 from BASF SE)
Chain extender 1: propylene glycol-based, Fn = 2, molecular weight = 134 g/mol
Aromatic diol: bisphenol-A-initiated polyether polyol based on propylene oxide, Fn = 2, number average molecular weight 400 g/mol
Chain extender 2: propylene glycol-based, Fn = 2, MW = 190 g/mol
Chain extender 3: diethylene glycol
Catalyst 1: tertiary aliphatic amine
Stabilizer 1: silicone-containing stabilizer for polyurethane foams
Isocyanate 1: mixtures of diphenylmethane diisocyanate and polymeric diphenylmethane diisocyanate, viscosity 200 mPa*s at 25° C.
Isocyanate 2: a prepolymer formed from 95.2 parts of mixtures of diphenylmethane diisocyanate and polymeric diphenylmethane diisocyanate and 4.8 parts of a polyesterol formed from 1 part of adipic acid, 6 parts of oleic acid and 2 parts of pentaerythritol, viscosity 250 mPa*s at 25° C.

Glass fiber mats: continuous strand mats of glass fibers, Unifilo® U809-450 from OwensCorningVetrotex

Hollow glass spheres: iM30K hollow glass sphere from 3M, having a density of 600 g/L and an average diameter of 15 μM

Production of Reinforced Polyurethane Rigid Foams (Variant 2):

TABLE 2

| | V4 | V5 | 3 | V1 | V2 | V6 | V7 | V8 |
|---|---|---|---|---|---|---|---|---|
| polyether 1 | 31 | 31 | 31 | 40 | 40 | 39 | | |
| polyether 2 | | | | 25 | 25 | 24 | | |
| polyether 4 | | | | | | | 20 | 20 |
| polyester 1 | 56 | 28 | 28 | 25 | 25 | 24 | | |
| polyester 2 | | | | | | | 40 | 40 |
| chain extender 1 | 10 | 10 | 10 | 10 | 10 | 10 | | |
| chain extender 2 | | 28 | 28 | | | | | |
| chain extender 3 | | | | | | | 40 | 40 |
| glycerol | 3 | 3 | 3 | | | 3 | | |
| water | 1.4 | 1.45 | 1.45 | 1.0 | 1.0 | 1.05 | 1.6 | |
| 1,1,1,3,3-pentafluoropropane | 0 | 0 | 0 | 0 | 0 | 0 | 0 | 10 |
| catalyst 1 | 0.11 | 0.07 | 0.07 | 0.08 | 0.08 | 0.08 | 0.12 | 0.13 |
| stabilizer 1 | 2.0 | 2.0 | 2.0 | 1.5 | 1.5 | 1.5 | 2 | 2 |
| isocyanate 1 | 166 | 183 | 183 | 126 | 126 | 140 | 209 | 187 |
| plies of glass fiber mats/weight | 0 | 0 | 7/12 | 0 | 7/12 | 0 | 0 | 0 |
| fraction of mats based on all | | | | | | | | |
| components (a) to (e) | | | | | | | | |
| foam density in g/L | 100 | 100 | 112 | 100 | 112 | 100 | 100 | 100 |
| compressive strength in MPa | 1.03 | 0.94 | 1.24 | 0.91 | 1.15 | 0.80 | 0.95 | 0.99 |
| compressive E-modulus in MPa | 27.7 | 26.6 | 48.2 | 24.8 | 43.1 | 22.4 | 26.4 | 25.4 |
| tensile strength in MPa | 1.28 | 1.22 | 1.39 | n.d. | n.d. | 0.99 | 0.95 | 0.91 |
| tensile E-modulus in MPa | 41.3 | 36.5 | 99.3 | n.d. | n.d. | 32.0 | 16.7 | 21.2 |
| 3-point flexural strength in MPa | n.d. | 1.78 | 2.85 | 1.62 | 1.91 | n.d. | n.d. | n.d. |
| 3-point flexural E-modulus in | n.d. | 23.8 | 47.3 | n.d. | n.d. | n.d. | n.d. | n.d. |
| MPa | | | | | | | | |
| shear strength in MPa | 1.02 | 0.94 | 0.90 | 0.83 | 0.79 | 0.87 | 0.81 | 0.82 |

The two tables report the quantities of the materials used in parts by weight. To produce the rigid foams as per inventive examples 1 to 3 and comparative (V) examples 1 to 8, the polyols used as per table 1 or table 2 were stirred together with catalysts, stabilizer and blowing agents, then mixed with the isocyanate and the reaction mixture poured into a box having a base area of 225 mm×225 mm and foamed up therein. The amount of water was chosen such that the unreinforced foam had a free foam density of 100 g/L. The foam densities reported in the tables are based on the overall density of the foam cube inclusive of reinforcing agent, if used. To produce the reinforced rigid foams as per inventive example 3 and comparative example 2, the reaction mixture was introduced into the same box, but it now contained multiple plies of glass fiber mats. The reaction mixture penetrated into the mats and as the foam rose in the box the mats swelled up and became homogeneously distributed throughout the entire foam height. To produce the reinforced rigid foams as per inventive examples 1 and 2 and comparative example 3, the hollow glass spheres were stirred up together with the polyols, catalysts, stabilizer and blowing agents used and then proceeded with as in comparative examples 4 to 8 and comparative example 1. To determine the mechanical properties, cube-shaped test specimens were sawn out of the interior of the foams. When the test specimens had a density other than 100 g/L, the values obtained in the mechanical tests were converted to a density of 100 g/L.

As can be seen from table 1 and table 2, formulations according to the present invention lead to rigid polyurethane foams having particularly high mechanical properties compared with hitherto known pressure- and shear-resistant rigid foams. Even without the use of reinforcing agents, these rigid polyurethane foams display such polyurethane foams already display good mechanical properties, as is evident from comparative example 5. This is particularly clear from the comparison with comparative examples V1 and V2, in which a foam as per example 1 of WO 2010/066635 was reproduced once with and once without reinforcing agents. Comparative example V6 shows a modified WO 2010/066635 recipe, further comprising the crosslinking agent glycerol. The mechanical properties of this non-reinforced foam are inferior compared with a non-reinforced form as per comparative example 5. The processing and application of the polyurethane reaction mixture and the visual impression of the foam is very good according to the inventive examples as with the comparative examples V1 and V2. Comparative examples V7 and V8 show a foam as per example 1 of EP 2236537, once with a physical blowing agent and once with the blowing agent water. The mechanical properties of a non-reinforced foam are distinctly inferior compared with a non-reinforced foam from comparative example 5, especially tensile strength, tensile E-modulus and shear strength. Moreover, the attempt to produce a reinforced polyurethane foam similarly to inventive example 3 and comparative example V2 failed, since the polyurethane reaction mixture of comparative tests V7 and V8 did not wet the glass fiber mats sufficiently, and so these did not become uniformly distributed in the rising foam.

Table 3 shows that a reinforced polyurethane rigid foam as per inventive example 1 has a distinctly improved heat resistance compared with PVC foams and compared with foams as per comparative example 1.

TABLE 3

| | Crosslinked | | |
|---|---|---|---|
| Foam | PVC foam | Comparative 1 | Inventive 1 |
| softening | 82° C. | 123° C. | 144° C. |
| temperature [° C.] | | | |

We claim:

1. A reinforced polyurethane foam having a density of above 50 to 300 g/L, a density-independent compressive strength of above 7.5*10⁻⁴ MPa (L/g)^{1.6}, a density-independent compressive modulus of elasticity of above 1.7*10⁻² MPa (L/g)^{1.7}, a density-independent tensile strength of above 6.4*10⁻⁴ MPa (L/g)^{1.6}, a density-independent tensile modulus of elasticity of above 2.4*10⁻² MPa (L/g)^{1.7}, a density-independent flexural strength of above 1.25*10⁻³ MPa (L/g)^{1.6}, and a density-independent flexural modulus of elasticity of above 1.75*10⁻² MPa (L/g)^{1.7}, obtainable by mixing
a) polyisocyanates with
b) compounds having isocyanate-reactive groups,
c) blowing agent comprising water, and optionally
d) catalyst and
e) further additives,
to form a reaction mixture and curing the reaction mixture, wherein the reaction mixture to be cured comprises from 1% to 40% by weight of hollow microspheres and/or is applied to a porous reinforcing agent (f) capable of forming two-dimensional or three-dimensional networks in the polyurethane foam, the compounds having isocyanate-reactive groups (b) comprise polyetherols (b1), polyesterols (b2), chain extenders (b3) and optionally crosslinkers (b4) and aromatic polyether diols (b5), and said component (b) comprises a fraction of polyesterols (b2), chain extenders (b3) and aromatic polyether diols (b5) that is equal to at least 50% by weight, based on the total weight of said component (b).

2. The reinforced polyurethane foam according to claim 1, wherein at least 50% by weight of said component (b) comprises compounds having two or three isocyanate-reactive groups.

3. The reinforced polyurethane foam according to claim 2, wherein the molecular weight of the compounds having two or three isocyanate-reactive groups is less than 2500 g/mol.

4. The reinforced polyurethane foam according to claim 2 or 3, wherein the number average molecular weight of the compounds having two or three isocyanate-reactive groups is less than 500 g/mol.

5. The reinforced polyurethane foam according to claim 1, wherein the compounds having isocyanate-reactive groups (b) comprise at least 50% by weight of compounds having two isocyanate-reactive groups and a molecular weight of less than 2500 g/mol, based on the total weight of said component (b).

6. The reinforced polyurethane foam according to any one of claims 1 to 5, wherein the proportion of polyesterols (b2) is at least 50% by weight, based on the total weight of said component (b).

7. The reinforced polyurethane foam according to any one of claims 1 to 6, wherein said polyesterols (b2) comprise hydrophobic polyesterols.

8. The reinforced polyurethane foam according to any one of claims 1 to 5, wherein the proportion of chain extender (b3) is in the range from 8% to 50% by weight, based on the total weight of said component (b), and the proportion of crosslinker (b4) is in the range from 0% to 10% by weight, based on the total weight of said component (b).

9. The reinforced polyurethane foam according to any one of claims 1 to 8, wherein the average functionality of said component (b) is below 3.0.

10. The reinforced polyurethane foam according to any one of claims 1 to 9, wherein said polyetherols (b1) have an average functionality in the range from 3.6 to 8.

11. The reinforced polyurethane foam according to any one of claims 1 to 10, wherein said reinforcing agent (f) comprises glass fiber mats.

12. The reinforced polyurethane foam according to any one of claims 1 to 10, wherein said reinforcing agent (f) comprises hollow microspheres.

13. A process for producing a reinforced polyurethane foam comprising mixing
a) polyisocyanates with
b) compounds having isocyanate-reactive groups,
c) blowing agent comprising water, and optionally
d) catalyst and
e) further additives,
to form a reaction mixture and curing the reaction mixture, wherein the reaction mixture to be cured comprises from 1% to 40% by weight of hollow microspheres and/or is applied to a porous reinforcing agent (f) capable of forming two-dimensional or three-dimensional networks in the polyurethane foam, the compounds having isocyanate-reactive groups (b) comprise polyetherols (b1), polyesterols (b2), chain extenders (b3) and optionally crosslinkers (b4) and aromatic polyether diols (b5), and said component (b) comprises a fraction of polyesterols (b2), chain extenders (b3) and aromatic polyether diols (b5) that is equal to at least 50% by weight, based on the total weight of said component (b).

14. The use of a reinforced polyurethane foam according to any one of claims 1 to 12 in a structural sandwich component.

15. The use of a reinforced polyurethane foam according to any one of claims 1 to 12 as a reinforcing foam in blades and wings or as insulation material for liquefied natural gas tanks.

16. The use according to claim 15, wherein the blades are rotor blades of a wind power system.
